(19) United States
(12) Patent Application Publication
(10) Pub. No.: US 2020/0002077 A1
(43) Pub. Date: Jan. 2, 2020

(54) BEVERAGE CONTAINER WITH INTEGRATED MASSAGING APPARATUS

(71) Applicant: Ryan Broderick Latone, Aventura, FL (US)

(72) Inventor: Ryan Broderick Latone, Aventura, FL (US)

(21) Appl. No.: 16/453,819

(22) Filed: Jun. 26, 2019

Related U.S. Application Data
(60) Provisional application No. 62/692,304, filed on Jun. 29, 2018.

(51) Int. Cl. B65D 81/36; A61H 15/00; B65D 47/04; A45F 3/18

(52) U.S. Cl. CPC B65D 81/36; A61H 15/0092; A61H 2015/0064; A45F 3/18; A61H 2015/0014; B65D 47/046

(57) ABSTRACT

Beverage containing massage devices that may perform multiple physical recovery functions are disclosed. In an aspect, beverage containing massage devices are disclosed that may be used to transport at least one beverage, such as water, as well as manipulate the soft tissue with at least one portion of a user's body in order to produce a massaging effect. By giving the user a beverage to flush toxins from the body and hydrate, as well as self-induced soft tissue manipulation to break up muscle adhesions, reduce tension and soreness, and improve cardiovascular circulation, the beverage containing massage devices of the present disclosure may allow important physical recovery needs for active individuals to be met using a single device.

### CROSS REFERENCE TO RELATED APPLICATIONS

This application claims the benefit, and priority benefit, of U.S. Provisional Patent Application Ser. No. 62/692,304 filed Jun. 29, 2018, titled “WATER BOTTLE/MASSAGE DEVICE,” the disclosure of which is incorporated herein in its entirety.

### FIELD OF THE DISCLOSURE

The present disclosure generally relates to beverage containers and more particularly to beverage containers that comprise at least one portion that is configured to function as a massaging apparatus.

### BACKGROUND

The statements in this section merely provide background information related to the present disclosure and may not constitute prior art.

When an individual engages in various types of physical activities, such as running, exercising, lifting weights, doing chores or some work related activity, the effort exerted by the body creates a need for various types of nourishment and recovery support. For example, dehydration causes a need for water or other liquids, while muscular soreness may prompt a need for massaging forces to manipulate soft tissues and break up muscle adhesions.

In a culture that is becoming more and more mobile, finding devices that are easily transported on one's person is of the utmost importance. Devices that are not easily transported often do not get used, and the benefit(s) that could be derived from those devices are forgone. With regard to hydration and massage needs, water bottles are available in a variety of forms that may be selected based on a user's needs and desires; however, currently available massage devices are separate and distinct from the water bottles, and some of them are large and cumbersome. Being that hydration needs often trump massage needs, when forced to carry a limited amount of items from place to place, an individual will typically select a water bottle while leaving massage device(s) behind. This may result in untreated muscle soreness or discomfort that can negatively affect performance, productivity, mood, and potentially lead to an injury.

Given the foregoing, what is needed are beverage containers that comprise at least one integrated portion that is configured to function as a massaging apparatus.

### SUMMARY

This Summary is provided to introduce a selection of concepts. These concepts are further described below in the Detailed Description section. This Summary is not intended to identify key features or essential features of this disclosure's subject matter, nor is this Summary intended as an aid in determining the scope of the disclosed subject matter.

Aspects of the present disclosure meet the above-identified needs by providing beverage containing massage devices that are integrated with one or more massage apparatuses. Specifically, in an aspect, beverage containing massage devices are disclosed that comprise at least one portion that is configured to allow a user to engage in at least partially self-imposed soft tissue manipulation in order to, among other things, break up muscle adhesions and relieve muscle soreness.

In some aspects, the beverage containing massage devices in accordance with the present disclosure may comprise at least one liquid reservoir configured to contain at least one amount of liquid, such as a beverage (e.g., water). The liquid reservoir may comprise at least one opening, such as at an upper portion of the liquid reservoir, that may be configured to receive at least one removable sealing element, such as a cover or lid. In some additional aspects, a substantially hollow elongated member (e.g., a straw) may extend down from an upper surface of the sealing element, traversing an interior portion of the sealing element, and reaching down into the liquid reservoir to assist a user in imbibing an amount of liquid from the liquid reservoir.

In some aspects, the beverage containing massage devices in accordance with the present disclosure may be integrated with at least one massage apparatus in the form of a massage roller. In some additional aspects, the massage roller may comprise one or more ball bearings. In still some additional aspects, the massage roller may be configured to be removably or permanently received within at least one indentation integrated with the beverage containing massage devices of the present disclosure.

In some aspects, the beverage containing massage devices in accordance with the present disclosure may comprise at least one recess configured to removably or permanently receive at least one spherical element (e.g., a ball). In some additional aspects, one or more spherical elements may be securely contained within at least one substantially flat panel member, which may be removably received as a single element from the at least one recess within a beverage containing massage device in accordance with the present disclosure.

In some aspects, the beverage containing massage devices in accordance with the present disclosure may comprise one or more portions that are substantially flexible and pliable in order to make the beverage containing massage devices less prone to impact damage and/or more comfortable when contacting a portion of a user's body.

In some aspects, the beverage containing massage devices in accordance with the present disclosure may comprise one or more portions that are integrated with one or more grooves, ridges, bumps, or protrusions configured to decrease the coefficient of friction and thereby decrease slippage when received within a user's hand.

Further features and advantages of the present disclosure, as well as the structure and operation of various aspects of the present disclosure, are described in detail below with reference to the accompanying drawings.

### BRIEF DESCRIPTION OF THE DRAWINGS

The features and advantages of the present disclosure will become more apparent from the Detailed Description set forth below when taken in conjunction with the drawings in which like reference numbers indicate identical or functionally similar elements.

FIG. 1 is an exploded view of an exemplary beverage containing massage device, according to an aspect of the present disclosure.

FIG. 2 is a first side view of an exemplary beverage containing massage device, according to an aspect of the present disclosure.

FIG. 3 is a second side view of an exemplary beverage containing massage device, according to an aspect of the present disclosure.

FIG. 4 is a third side view of an exemplary beverage containing massage device, according to an aspect of the present disclosure.

FIG. 5 is a fourth side view of an exemplary beverage containing massage device, according to an aspect of the present disclosure.

FIG. 6 is a top view of an exemplary beverage containing massage device, according to an aspect of the present disclosure.

FIG. 7 is a bottom view of an exemplary beverage containing massage device, according to an aspect of the present disclosure.

FIG. 8 is a front perspective view of an exemplary beverage containing massage device, according to an aspect of the present disclosure.

FIG. 9 is a rear perspective view of an exemplary beverage containing massage device, according to an aspect of the present disclosure.

FIG. 10 is an image of a user using an exemplary beverage containing massage device to massage one or more front portions of a torso of the user using at least one massage roller, according to an aspect of the present disclosure.

FIG. 11 is an image of a user using an exemplary beverage containing massage device to massage one or more portions of at least one lower limb of the user, according to an aspect of the present disclosure.

FIG. 12 is an image of a user using an exemplary beverage containing massage device to massage one or more portions of at least one upper limb of the user, according to an aspect of the present disclosure.

FIG. 13 is an image of a user using an exemplary beverage containing massage device to massage one or more rear portions of a torso of the user, according to an aspect of the present disclosure.

FIG. 14 is an image of a user using an exemplary beverage containing massage device to massage one or more front portions of a torso of the user using one or more massage balls, according to an aspect of the present disclosure.

### DETAILED DESCRIPTION

The present disclosure is directed to beverage containing massage devices that may comprise at least one portion that is configured as a massaging apparatus. Specifically, in an aspect, beverage containing massage devices are described that are integrated with at least one massaging apparatus that may be configured to manipulate one or more soft tissues, such as muscle, of a user when physically pressed against the soft tissue(s) using an amount of force. In some aspects, the at least one massaging apparatus may comprise one or more massage rollers, one or more balls, and the like.

The term “beverage containing massage device” and/or the plural form of this term are used throughout herein to refer to any device, apparatus, mechanism, or combination thereof that may comprise at least one reservoir with at least one opening, wherein the at least one reservoir is configured to be capable of containing at least one amount of at least one liquid, and at least one massaging apparatus. By way of example and not limitation, a beverage containing massage device may comprise a canister, a bottle, a cup, a carafe, a mug, a flask, a jug, and the like integrated, permanently or temporarily, with at least one massaging apparatus. A beverage containing massage device may not always contain at least one amount of at least one liquid, so long as it is capable of containing such.

The term “massaging apparatus” and/or the plural form of this term are used throughout herein to refer to any apparatus, device, mechanism, or combination thereof configured to provide soft tissue manipulation to one or more portions of a body of a living animal, such as a human body, when physically applied to those portion(s) using an amount of force. By way of example and not limitation, a massaging apparatus may comprise a massage roller (e.g., foam roller, stick roller, therapy cane, etc.), a massage ball, and other targeted release and massage apparatuses as may be developed in the future.

The term “user” and/or the plural form of this term are used throughout herein to refer to any individual that may use the beverage containing massage devices and/or massaging apparatuses integrated therewith in accordance with the present disclosure, such as athletes, trainers, active individuals, working professionals, and the like.

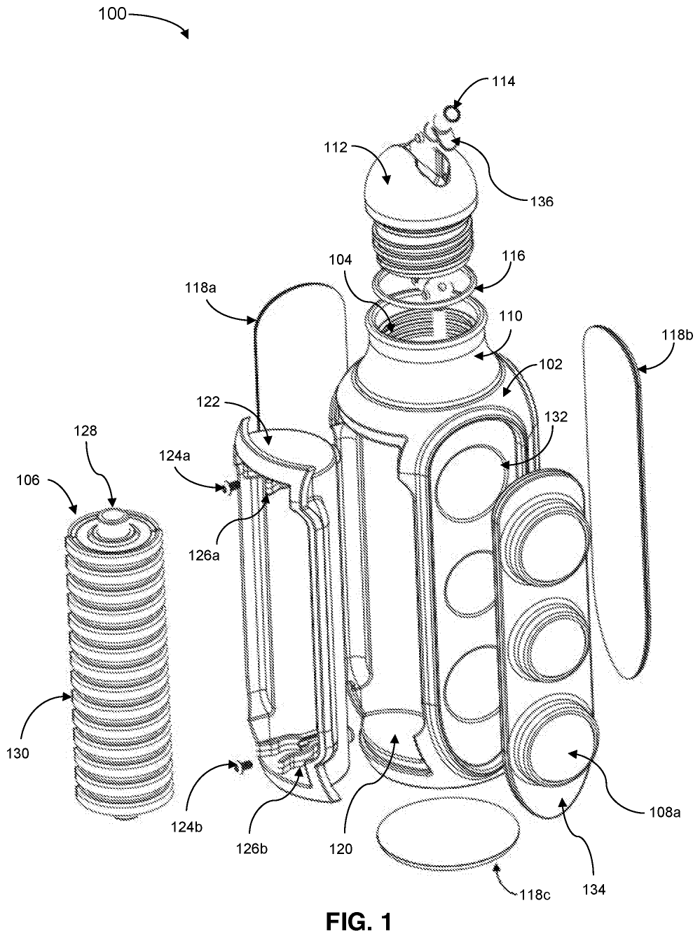

Referring now to FIG. 1, an exploded view of an exemplary beverage containing massage device 100, according to an aspect of the present disclosure, is shown.

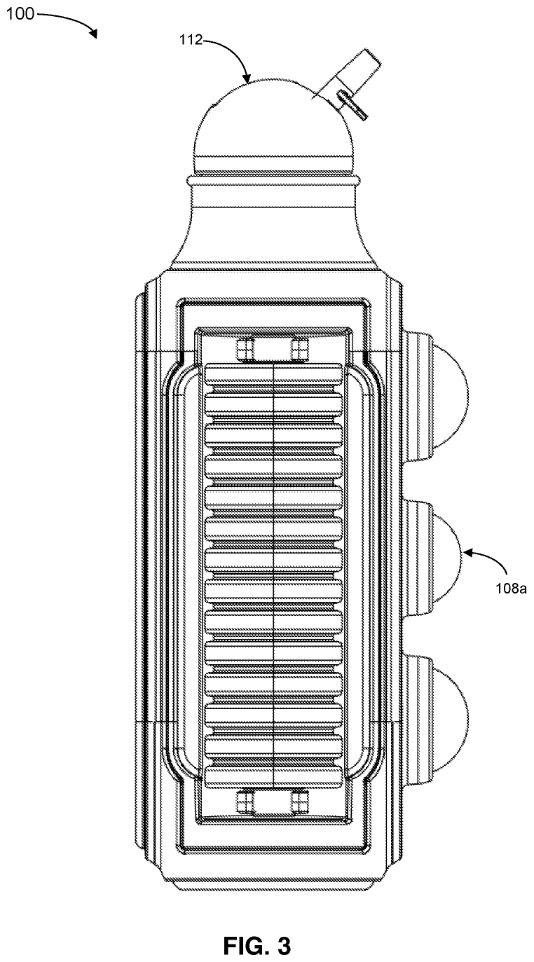

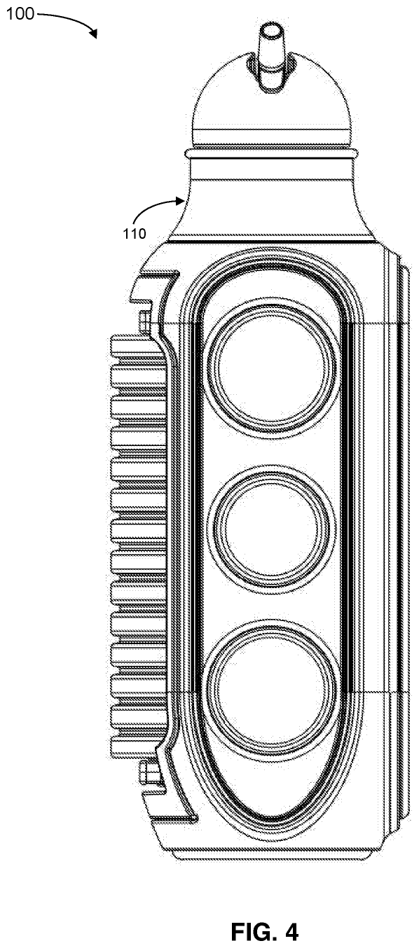

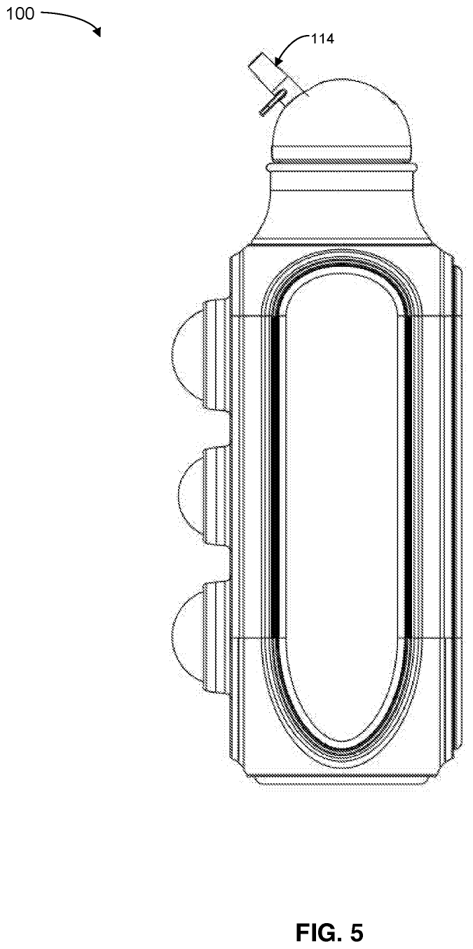

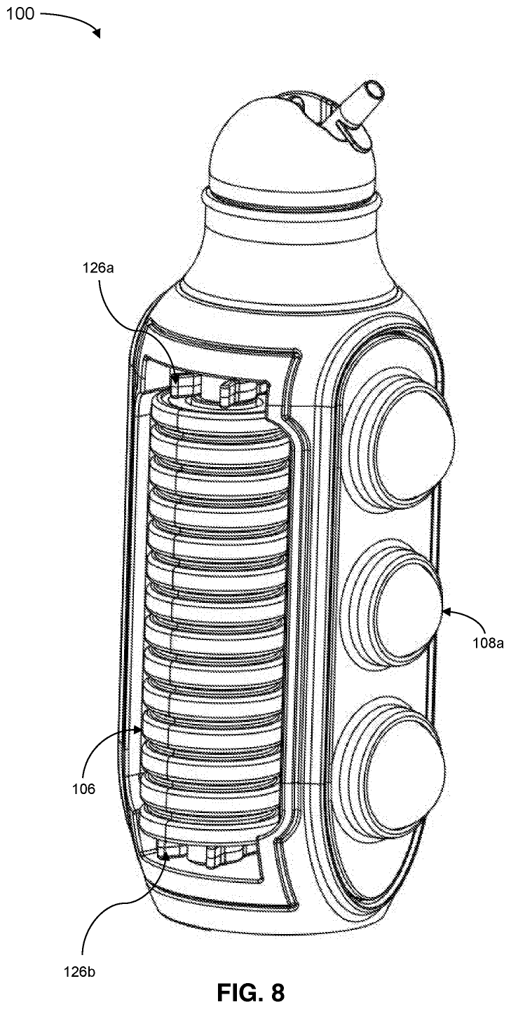

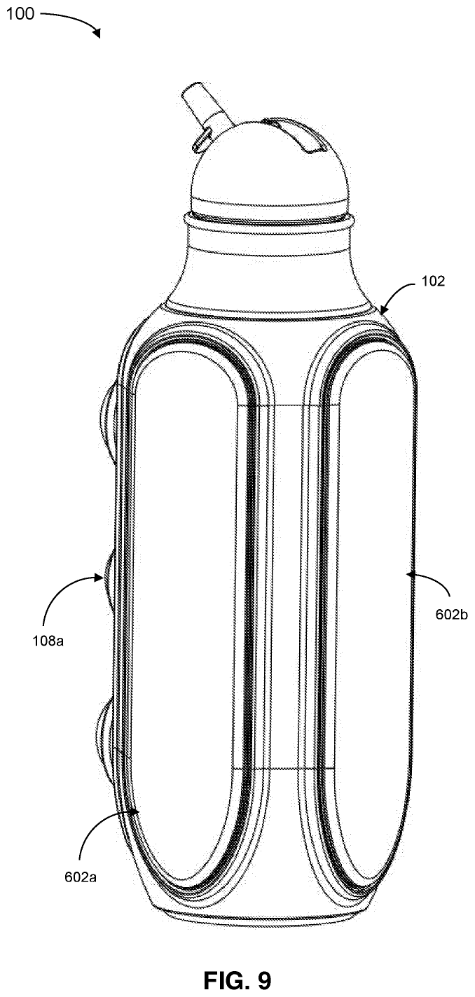

As shown in FIGS. 1-9, in some aspects, beverage containing massage device 100 may comprise at least one at least partially enclosed reservoir 102 that includes at least one opening 104 and at least one substantially hollow portion, and at least one massaging apparatus, such as, by way of example and not limitation, at least one massage roller 106 and/or at least one massage ball 108 (shown as massage balls 108a-c in FIG. 1).

Reservoir 102 may be configured to hold at least one amount of at least one liquid within the at least one substantially hollow portion. In some aspects, the at least one liquid may be consumable by at least one human user 1002 (not shown in FIG. 1). By way of example and not limitation, the at least one liquid may comprise water, a sports drink (such as, by way of example and not limitation, Gatorade®, available from the Gatorade Company, Inc. of Chicago, Ill.), tea, soda, juice, coffee, and the like, as well as any combination thereof. The at least one amount of the at least one liquid may be received into and removed from reservoir 102 via at least one opening 104. In some additional nonlimiting exemplary embodiments, at least one upper portion of reservoir 102 may comprise cross section that is at least slightly smaller than the cross section of the rest of reservoir 102, thereby forming a neck portion 110 that may extend upwardly toward opening 104. By way of further example and not limitation, reservoir 102 may take the form of a canister, a bottle, a cup, a carafe, a mug, a flask, a jug, as well as any similar form as may be apparent to those skilled in the relevant art(s) after reading the description herein. By way of still further example and not limitation, reservoir 102 may be comprised of stainless steel, one or more plastics or other polymers (especially those that may be free of chemicals that may cause leaching), aluminum, one or more metal alloys, titanium, and the like.

In some aspects, beverage containing massage device 100 may further comprise at least one sealing element 112. Sealing element 112 may be configured to at least partially block opening 104 by interacting with one or more structures near opening 104 in order to be removably secured therewith. For example, and not limitation, a ridge protruding from an outer or inner surface of opening 104 in the form of a helix may be configured to receive sealing element 112 by way of a twisting or other rotational application of force, while a ridge protruding from an outer or inner surface of opening 104 in the form of a circle may be configured to receive sealing element 112 via a pushing force that “snaps” sealing element 112 into place. In some nonlimiting exemplary embodiments, sealing element 112 may comprise a lid, cap, topper, as well as any similar structure(s) as may be apparent to those skilled in the relevant art(s) after reading the description herein.

In some aspects, sealing element 112 may include at least one substantially hollow elongated member 114 (such as, by way of example and not limitation, a straw), that spans from an upper portion of sealing element 112, through at least one portion of sealing element 112, and into a hollow portion of reservoir 102. A user 1002 may use elongated member 114 to remove at least one amount of at least one liquid from reservoir 102 without removing sealing element 112. In some aspects, elongated member 114 may be comprised of an at least partially flexible material, such as plastic, rubber, and the like. An upper distal portion of elongated member 114 may protrude outwardly from an upper surface of sealing element 112 while a lower portion of elongated member 114 may extend down into reservoir 102. In some nonlimiting exemplary embodiments, the upper distal portion of elongated member 114 may be alterable from an “exposed” position, wherein it may be readily accessible by a mouth of at least one user 1002 and a “hidden” position wherein it may be at least partially concealed within a portion of sealing element 112. By way of example and not limitation, one or more hinges may be used to allow elongated member 114 to be altered between the two positions. One or more notches 604 (not shown in FIG. 1) and/or tabs 136 may be integrated with the upper distal portion of elongated member 114 in order to assist one or more users 1002 in altering elongated member 114 from one position to another as well as to at least partially conceal elongated member 114 when it is in the hidden position. In some additional aspects, at least one sealing ring 116 may be included between sealing element 112 and the outer edge(s) of opening 104 in order to form a more secure seal and prevent spillage of any liquid(s) from within reservoir 102. Sealing ring may be comprised of any appropriate material(s) as may be apparent to those skilled in the relevant art(s) after reading the description herein, including but not limited to one or more plastics, rubber, one or more thermoplastic elastomers, one or more other polymers, and the like.

In some aspects, beverage containing massage device 100 may comprise at least one at least partially malleable element 118 (shown as malleable elements 118a-c in FIG. 1). Malleable element(s) 118 may be configured upon or integrated with one or more outer surfaces of the beverage containing massage device 100 in order to protect the reservoir 102 and the beverage containing massage device 100, generally, as well as to reduce the amount of discomfort experienced by a user 1002 when beverage containing massage device 100 may be physically pressed against one or more parts of a body of user 1002 and/or to help prevent beverage containing massage device 100 from slipping out of place during use. By way of example and not limitation, malleable element(s) 118 may be securely and removably affixed to one or more outer surfaces of beverage containing massage device 100 using, for example, epoxy, one or more adhesives, and/or via one or more other fastening elements, such as one or more hook-and-loop fasteners, nails, screws, stitches, as well as any similar fastening element(s) as may be developed in the future, including any combination thereof. In some aspects, malleable element(s) 118 may be removable from the beverage containing massage device 100 for any reason, for example, for cleaning or replacement purposes or if the user simply does not desire the beverage containing massage device 100 to have this element. In some additional aspects, malleable element(s) 118 may be comprised of one or more materials with shock absorbing capabilities. By way of further example and not limitation, appropriate materials for malleable element(s) 118 may include foam, rubber (including recycled rubber material), one or more plastics, vinyl, cotton or other fabrics, leather, one or more other polymers, or any similar material(s) as may be apparent to those skilled in the relevant art(s) after reading the description herein, as well as any combination thereof.

In some aspects, at least one outer portion of at least one exterior surface of beverage containing massage device 100 may comprise more one or more grooves, ridges, bumps, protrusions, and/or similar structures or friction reducing elements, some of which may be removable, configured to have a lower coefficient of friction compared to other exterior surfaces of beverage containing massage device 100 and thereby reduce the likelihood of having beverage containing massage device 100 slip within a hand of user 1002. By way of example and not limitation, the friction reducing element(s) may be configured upon one or more exterior surfaces of neck portion 110, when applicable.

In aspects wherein beverage containing massage device 100 may include at least one massaging apparatus in the form of at least one elongated rolling member such as massage roller 106, beverage containing massage device 100 may comprise at least one portion, such as a side, that comprises at least one indentation 120 configured to securely receive at least one roller capture housing 122. Roller capture housing 122 may be at least partially contained and secured within indentation 120 either permanently or removably via one or more screws, nails, clasps, clamps, clips, adhesives, bolts, nuts, washers, and/or any similar fastening element(s) as may be apparent to those skilled in the relevant art(s) after reading the description herein, including any combination thereof. By way of example and not limitation, roller capture housing 122 may be secured within indentation 120 using two screws 124 (labeled as screws 124a-b in FIG. 1). By way of further example and not limitation, roller capture housing may comprise one or more materials that may also be appropriate for reservoir 102, such as stainless steel, one or more plastics or other polymers, aluminum, one or more metal alloys, titanium, as well as any similar material(s) as may be apparent to those skilled in the relevant art(s) after reading the description herein, including any combination thereof.

Roller capture housing 122 may be configured to permanently or removably receive and at least partially contain massage roller 106 via one or more receiving elements 126 (shown as receiving elements 126a-b in FIG. 1). By way of example and not limitation, receiving element(s) 126 may comprise clasps, clamps, clips, grooves, slits, notches, holes, springs, or any similar appropriate structure(s) or element(s) as may be apparent to those skilled in the relevant art(s) after reading the description herein, including any combination thereof. In some nonlimiting exemplary embodiments, receiving elements 126 may comprise tube clips. In some aspects, the tube clips may be pliable enough to open slightly to receive a portion of massage roller 106 such as, by way of example and not limitation, an internal rigid shaft member 128 of massage roller 106. Upon receiving the relevant portion(s) of massage roller 106, the tube clips may close securely around those portion(s) and form a tension based fit. The tension based fit may be configured to be permanent or temporary; in aspects wherein the tension based fit may be temporary, it may be overcome when a user 1002 uses force to pull shaft member 128 and the associated massage roller 106 out of the tube clips, causing them to open just enough to release shaft member 128. As will be appreciated by those skilled in the relevant art(s) after reading the description herein, other receiving element(s) 126 may be configured to permanently or temporarily receive one or more portions of shaft member 128.

In some aspects, a massage roller 106 associated with beverage containing massage device 100 may comprise a substantially rigid elongated shaft member 128. In some nonlimiting exemplary embodiments, shaft member 128 may be the portion of massage roller 106 about which a roller portion 130 revolves during use. Roller portion 130 may comprise the portion of massage roller 106 that actually contacts one or more portions of a body of a user 1002 during use. By way of example and not limitation, roller portion 130 may be comprised of one or more at least partially pliable materials, such as foam, vinyl, one or more plastics, rubber, leather, one or more other polymers, and the like, while shaft member 128 may be comprised of one or more rigid materials, such as aluminum, stainless steel, one or more other metals, one or more relatively rigid plastics or other polymers, and the like. As will be apparent to those skilled in the relevant art(s) after reading the description herein, other materials may be used for roller portion 130 and/or shaft member 128 without departing from the scope of the present disclosure.

In some additional aspects, massage roller 106 may further comprise at least one covering member configured to at least partially cover massage roller 106. By way of example and not limitation, the covering member may be comprised of one or more plastics, one or more fabrics (e.g., such as those made from cotton), nylon, leather, and/or any similar material(s) as may be apparent to those skilled in the relevant art(s) after reading the description herein, including any combination thereof. In still some additional aspects, massage roller 106 may further comprise a plastic textured overmold.

In aspects wherein beverage containing massage device 100 may include at least one massage apparatus in the form of a substantially spherical element such as massage ball 108 (labeled only as massage ball 108a in FIG. 1, for clarity), beverage containing massage device 100 may comprise at least one portion, such as a side, that comprises at least one recess 132 within which massage ball(s) 108 may be at least partially contained, either removably or permanently. Each massage ball 108 used with beverage containing massage device 100 may be comprised of any appropriate material(s) as may be apparent to those skilled in the relevant art(s) after reading the description herein, such as, by way of example and not limitation, stainless steel, one or more plastics, rubber, one or more other metals, one or more other polymers, and the like. In some nonlimiting exemplary embodiments, multiple massage balls 108 may be at least partially contained together within a single massage ball holder 134. In some aspects, massage ball holder 134 may comprise an at least partially rigid planar element. Each massage ball 108 within massage ball holder 134 may be configured such that massage ball holder 134 passes through a central portion of each massage ball 108 contained therein. In some additional embodiments, each massage ball may be configured to freely rotate in any direction within massage ball holder 134.

In some aspects, one or more massage balls 108 and/or massage ball holder 134 may be temporarily or permanently at least partially contained within recess(es) 132 via one or more removably or permanently interlocking elements such as, by way of example and not limitation, notches, nooks, crevices, ridges, bumps, protrusions, slits, grooves, holes, and the like. In some additional aspects, massage ball(s) 108 and/or massage ball holder 134 may be removably or permanently received by recess(es) 132 and held into place by one or more fastening elements such as, by way of example and not limitation, clasps, clamps, hooks, springs, tabs, and the like. In still some additional aspects, one or more massage balls 108 may be removably received by recess(es) 132 and held in place by at least one outer cover, which may be removably secured by one or more interlocking elements such as, by way of example and not limitation, notches, nooks, crevices, ridges, bumps, protrusions, slits, grooves, holes, and the like; and/or by one or more fastening elements such as, by way of example and not limitation, clasps, clamps, hooks, springs, and the like. Other elements may be used to temporarily or permanently secure massage ball(s) 108 and/or massage ball holder 134 as may be apparent to those skilled in the relevant art(s) without departing from the scope of the present disclosure.

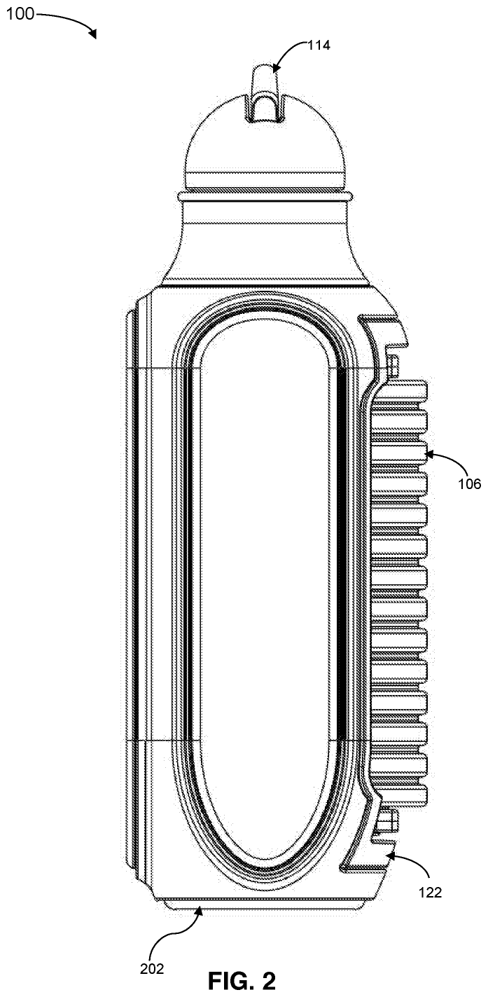

Referring now to FIGS. 2-5, various exemplary side views of a beverage containing massage device 100, according to aspects of the present disclosure, are shown. As discussed above, in some aspects, beverage containing massage device 100 may comprise a substantially flat and substantially rigid bottom portion 202, a sealing element 112, wherein sealing element 112 may include at least one substantially hollow elongated member 114, as well as the other elements discussed herein.

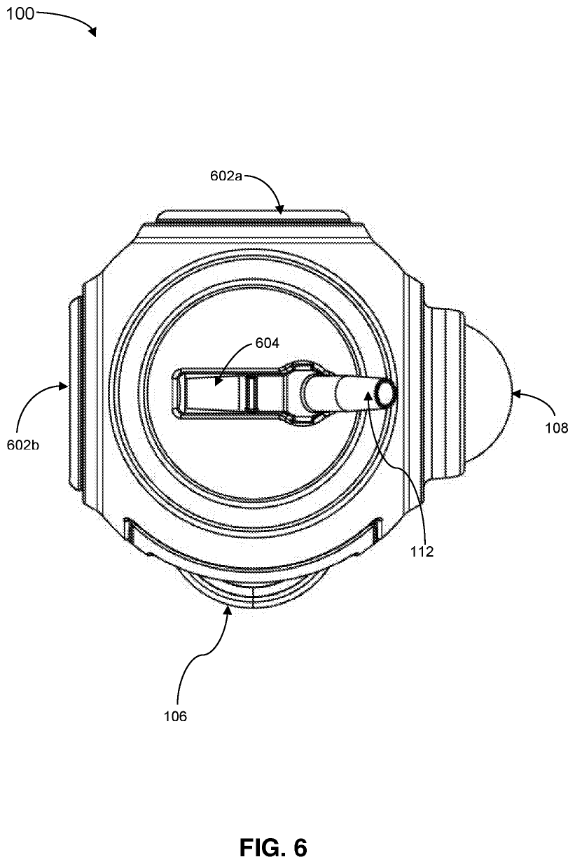

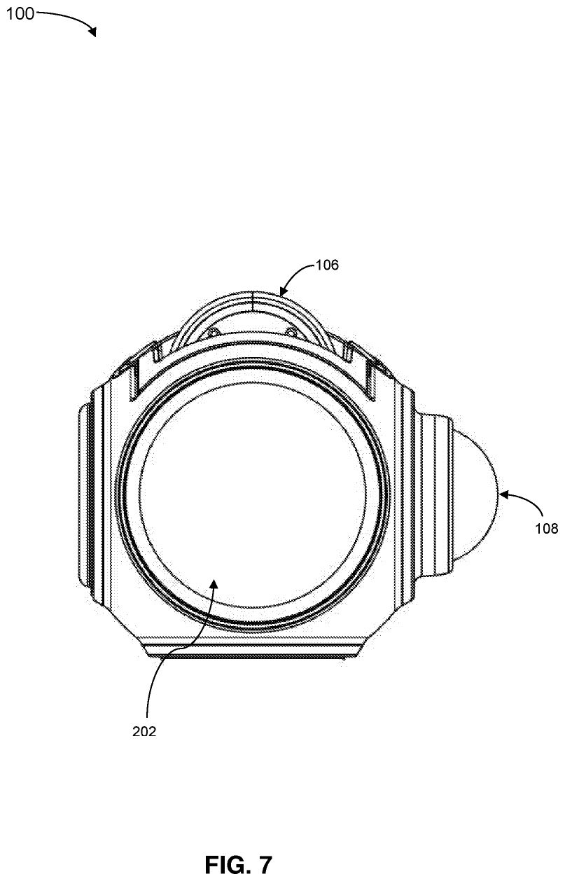

Referring now to FIGS. 6-7, top views of exemplary beverage containing massage devices 100, according to aspects of the present disclosure, are shown. As discussed above, in some aspects, beverage containing massage device 100 may comprise a substantially flat and substantially rigid bottom portion 202, a sealing element 112, wherein sealing element 112 may include at least one substantially hollow elongated member 114, as well as the other elements discussed herein.

As shown in FIGS. 6-9, in some aspects, beverage containing massage device 100 may comprise at least one substantially flat and substantially rigid side portion 602 (labeled as side portions 602a-b in FIG. 6) which may be removable from the beverage containing massage device 100 for various purposes, such as cleaning and/or replacement. In some additional aspects, at least one side portion 602 may be configured opposite to a side of beverage containing massage device 100 that comprises at least one massage roller 106, while at least one side portion 602 may be configured opposite to a side of beverage containing massage device 100 that comprises at least one massage ball 108. In still some additional aspects, an upper portion of sealing element 112 may comprise at least one notch 604 to at least partially conceal elongated member 114 when it is in a hidden position.

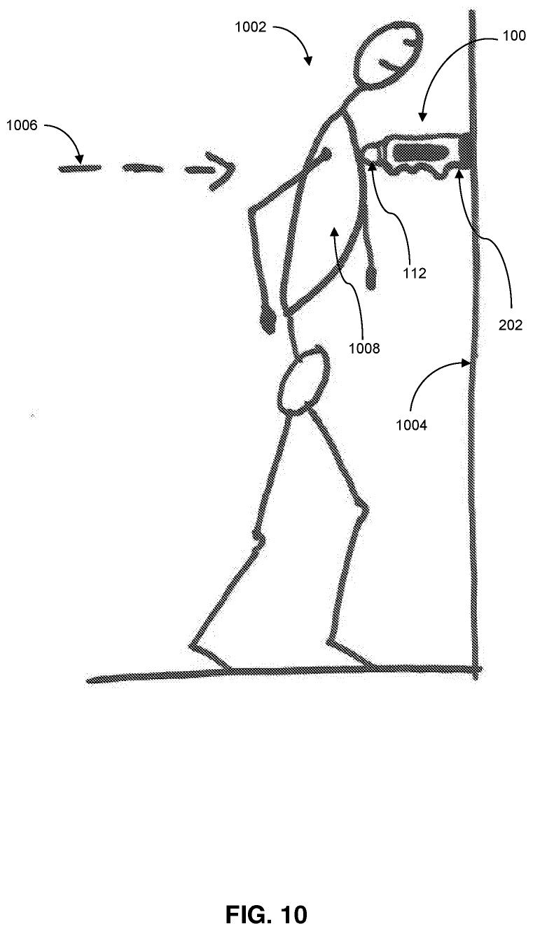

Referring now to FIG. 10, an image of a user 1002 using an exemplary beverage containing massage device 100 to massage one or more front portions of a torso 1008 of user 1002 using at least one massage roller 106, according to an aspect of the present disclosure, is shown.

In some nonlimiting exemplary embodiments, beverage containing massage device 100 may be placed perpendicularly against a substantially vertical, flat, and rigid surface 1004 (such as, by way of example and not limitation, an interior or exterior wall) such that a substantially flat bottom portion 202 of beverage containing massage device 100 may be substantially even with surface 1004 when making contact therewith. Bottom portion 202 of beverage containing massage device 100 may be located at a distal end of beverage containing massage device 100 that is opposite to the distal end that receives sealing element 112. With this orientation, user 1002 may face the wall (or other surface) and press a front portion of torso 1008 of user 1002 (e.g., chest, shoulder(s), abdomen, etc.) against the upper portion of sealing element 112 such that the direction of the applied force (represented by arrow 1006) is substantially parallel to the orientation of beverage containing massage device 100 and perpendicular to vertical surface 1004. The applied force may have the effect of massaging or otherwise manipulating one or more soft tissues at or near the region of contact between the body of user 1002 and the upper portion of sealing element 112 in order to break up adhesions and/or improve cardiovascular circulation therein and/or relieve tension and/or soreness associated therewith. By way of example and not limitation, user 1002 may achieve the desired force application by leaning into/against the upper portion of sealing element 112 as it is positioned horizontally between user 1002 and vertical surface 1004. As will be apparent to those skilled in the relevant art(s) after reading the description herein, user 1002 may lean into/against the upper portion of sealing element 112 using various angles in order to adjust the direction of force applied to the body and achieve different massaging effects. Similarly, various movements may also be used by user 1002 in order to experience different massaging effects, as long as enough pressure is maintained to keep beverage containing apparatus 100 in place between user 1002 and surface 1004 In some aspects, an upper portion of sealing element 112 may comprise a substantially curved or rounded shape, such as, by way of example and not limitation, a substantially hemispherical shape configured to manipulate at least one soft tissue of user 1002 when pressed against at least one portion of the body of user 1002 that comprises the at least one soft tissue. In some additional aspects, sealing element 112, particularly an upper portion of sealing element 112, may comprise one or more at least partially pliable materials, such as, by way of example and not limitation, foam, vinyl, one or more plastics, rubber, leather, one or more other polymers, as well as any similar material(s) as may be apparent to those skilled in the relevant art(s) after reading the description herein, including any combination(s) thereof, in order to decrease any discomfort that may be experienced by user 1002 when contacting an upper portion of sealing element 112. In still some additional aspects, at least one section of bottom portion 202 of beverage containing device 100 may comprise at least one malleable element 118 (or, in some embodiments, may not include a malleable element 118) in order to protect vertical surface 1004 from damage and/or to prevent bottom portion 202 from slipping while contacting vertical surface 1004. As will be apparent to those skilled in the relevant art(s) after reading the description herein, one or more additional and/or different friction reducing elements may be integrated with bottom portion 202 of beverage containing massage device 100, such as, by way of example and not limitation, one or more grooves, ridges, bumps, protrusions, and the like, as well as any combination thereof. Similarly, in some aspects, the at least one malleable element 118 may be removable from the beverage containing massage device 100 for any reason, for example, for cleaning or replacement purposes or if the user does not desire the beverage containing massage device 100 to have this feature.

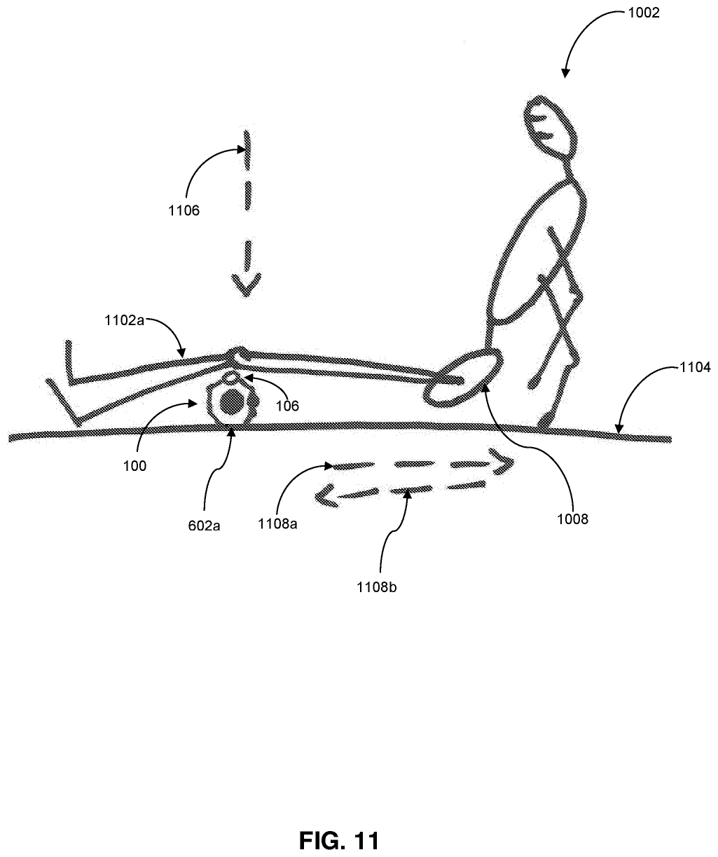

Referring now to FIG. 11, an image of a user 1002 using an exemplary beverage containing massage device 100 to massage one or more portions of at least one lower limb 1102 of user 1002, according to an aspect of the present disclosure, is shown.

In some nonlimiting exemplary embodiments, beverage containing massage device 100 may be placed on a substantially horizontal, flat, and rigid surface 1104 (such as, by way of example and not limitation, a section of interior flooring, the ground outdoors, a mat, etc.) such that at least one substantially flat side portion 602 (labeled only as side portion 602a in FIG. 11, for clarity) of beverage containing massage device 100 may be in substantially even contact with horizontal surface 1104. In some aspects, horizontal surface 1104 may comprise an at least slightly raised surface, such as, by way of example and not limitation, a table, desk, couch, bed, and the like. In some additional aspects, horizontal surface may be at least slightly inclined, such as, for example and not limitation, being inclined approximately thirty degrees. In still some additional aspects, the side portion 602 that contacts surface 1104 may be substantially opposite to the side of beverage containing massage device 100 that comprises massage roller 106. With this orientation, user 1002 may sit or lay on horizontal surface 1104 and lay at least one portion of at least one lower limb 1102 (labeled only as lower limb 1102a in FIG. 11, for clarity). By way of example and not limitation, the at least one portion of the at least one lower limb 1102 may comprise the back of a calf muscle. User 1002 may achieve one or more massaging effects for the desired portion(s) of lower limb(s) 1102 by applying a generally downward force (represented by arrow 1106) on beverage containing massage device 100 using lower limb(s) 1102 and, if necessary or desired, moving lower limb(s) 1102 in a generally sideways/horizontal direction such that the desired portion(s) of lower limb(s) 1102 to be massaged contact massage roller 106 in such a way as to receive a desired soft tissue manipulation. In some instances, one or more other portions of the body, or even the entire body of user 1002 may need to be moved in order to experience the desired massaging effects, such as, by way of example and not limitation, by oscillating the lower torso 1008 back and forth in a horizontal direction, as indicated by lines 1108a-b.

In some aspects, at least one section of side portion 602 of beverage containing massage device 100 that contacts horizontal surface 1104 may comprise at least one malleable element 118 (not shown in FIG. 11) in order to protect horizontal surface 1104 from damage and/or to prevent side portion 602 from slipping while contacting horizontal surface 1104. As will be apparent to those skilled in the relevant art(s) after reading the description herein, one or more additional and/or different friction reducing elements may be integrated with side portion 602 of beverage containing massage device 100, such as, by way of example and not limitation, one or more grooves, ridges, bumps, protrusions, and the like, as well as any combination thereof.

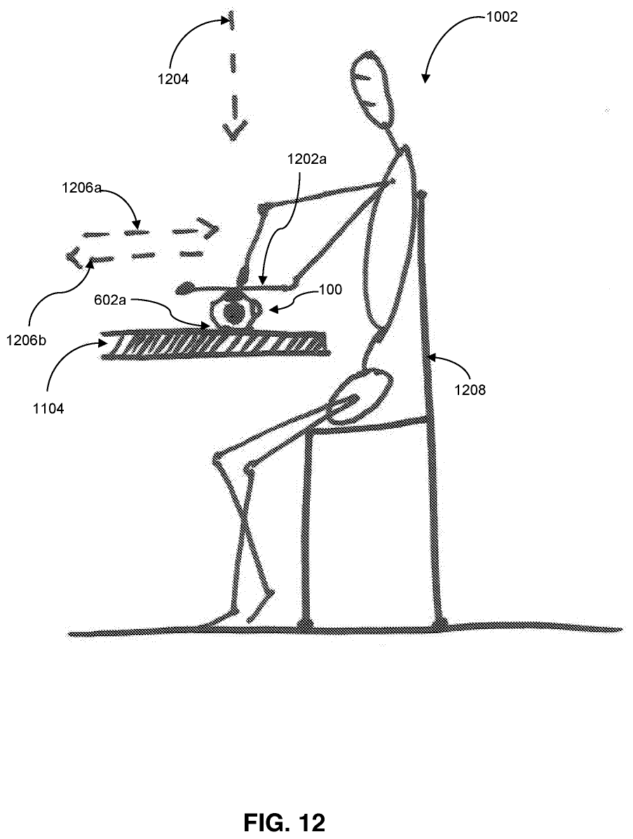

Referring now to FIG. 12, an image of a user 1002 using an exemplary beverage containing massage device 100 to massage one or more portions of at least one upper limb 1202 of user 1002, according to an aspect of the present disclosure, is shown.

In some nonlimiting exemplary embodiments, beverage containing massage device 100 may be placed on a substantially horizontal, flat, and rigid surface 1104 (such as, by way of example and not limitation, a section of interior flooring, the ground outdoors, a mat, etc.) such that at least one substantially flat side portion 602 (labeled only as side portion 602a in FIG. 12, for clarity) of beverage containing massage device 100 may be in substantially even contact with horizontal surface 1104. In some aspects, horizontal surface 1104 may comprise an at least slightly raised surface, such as, by way of example and not limitation, a table, desk, couch, bed, and the like. In some additional aspects, horizontal surface may be at least slightly inclined, such as, for example and not limitation, being inclined approximately thirty degrees. In still some additional aspects, the side portion 602 that contacts surface 1102 may be substantially opposite to the side of beverage containing massage device 100 that comprises massage roller 106. With this orientation, user 1002 may sit or lay on horizontal surface 1104 or, especially in instances wherein horizontal surface 1104 is raised, sit or lay on at least one piece of furniture 1208 and place at least one portion of at least one upper limb 1202 (labeled only as upper limb 1202a in FIG. 12, for clarity). By way of example and not limitation, the at least one portion of the at least one upper limb 1202 may comprise the back of a forearm muscle. User 1002 may achieve one or more massaging effects for the desired portion(s) of upper limb(s) 1202 by applying a generally downward force (represented by arrow 1204) on beverage containing massage device 100 using upper limb(s) 1202 and, if necessary or desired, oscillating upper limb(s) 1202 back and forth in a generally sideways/horizontal direction, as represented by lines 1206a-b, such that the desired portion(s) of upper limb(s) 1202 to be massaged contact massage roller 106 in such a way as to receive a desired soft tissue manipulation. In some instances, one or more other portions of the body of user 1002 may need to be moved in order to experience the desired massaging effects.

In some aspects, at least one section of side portion 602 of beverage containing massage device 100 that contacts horizontal surface 1104 may comprise at least one malleable element 118 in order to protect horizontal surface 1104 from damage and/or to prevent side portion 602 from slipping while contacting horizontal surface 1104. As will be apparent to those skilled in the relevant art(s) after reading the description herein, one or more additional and/or different friction reducing elements may be integrated with side portion 602 of beverage containing massage device 100, such as, by way of example and not limitation, one or more grooves, ridges, bumps, protrusions, and the like, as well as any combination thereof.

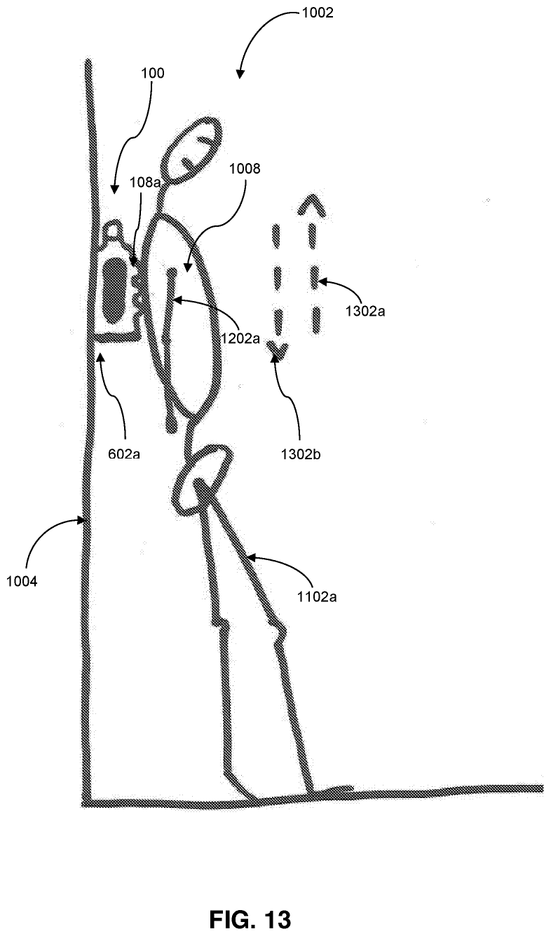

Referring now to FIG. 13, an image of a user 1002 using an exemplary beverage containing massage device 100 to massage one or more rear portions of a torso 1008 of user 1002, according to an aspect of the present disclosure, is shown.

In some nonlimiting exemplary embodiments, beverage containing massage device 100 may be placed substantially parallel to and against a substantially vertical, flat, and rigid surface 1004 (such as, by way of example and not limitation, an interior or exterior wall) such that at least one substantially flat side portion 602 (labeled only as side portion 602a in FIG. 13, for clarity) of beverage containing massage device 100 may be in substantially even contact with vertical surface 1004. In some aspects, the side portion 602 that contacts surface 1002 may be substantially opposite to the side of beverage containing massage device 100 that comprises one or more massage balls 108 (labeled only as massage ball 108a in FIG. 13, for clarity). With this orientation, user 1002 may face away from vertical surface 1004 and press a rear portion of torso 1008 of user 1002 (e.g., back, shoulder(s), neck, etc.) against the massage ball(s) 108 such that the applied force may have the effect of massaging or otherwise manipulating one or more soft tissues at or near the region of contact between the body of user 1002 and the exposed portion(s) of massage ball(s) 108 in order to break up adhesions and/or improve cardiovascular circulation therein and/or relieve tension and/or soreness associated therewith. By way of example and not limitation, user 1002 may achieve the desired force application by leaning into/against the exposed portion(s) of massage ball(s) 108 using various angles in order to adjust the direction of force applied to the body and achieve different massaging effects. Similarly, various movements may also be used by user 1002 in order to experience different massaging effects (such as, by way of example and not limitation, oscillating up and down movements, as represented by lines 1302a-b), as long as enough pressure is maintained to keep beverage containing apparatus 100 in place between user 1002 and vertical surface 1004. In some exemplary instances, user 1002 may even move one or more lower limbs 1102 (labeled only as lower limb 1102a in FIG. 13, for clarity) and/or one or more upper limbs 1202 (labeled only as upper limb 1202a in FIG. 13, for clarity) in order to achieve a wide range of massaging effects.

In still some additional aspects, at least one section of bottom portion 202 of beverage containing massage device 100 may comprise at least one malleable element 118 in order to protect vertical surface 1004 from damage and/or to prevent bottom portion 202 from slipping while contacting vertical surface 1004. As will be apparent to those skilled in the relevant art(s) after reading the description herein, one or more additional and/or different friction reducing elements may be integrated with bottom portion 202 of beverage containing massage device 100, such as, by way of example and not limitation, one or more grooves, ridges, bumps, protrusions, and the like, as well as any combination thereof.

In some aspects, at least one section of side portion 602 of beverage containing massage device 100 that contacts vertical surface 1004 may comprise at least one malleable element 118 in order to protect vertical surface 1004 from damage and/or to prevent side portion 602 from slipping while contacting vertical surface 1004. As will be apparent to those skilled in the relevant art(s) after reading the description herein, one or more additional and/or different friction reducing elements may be integrated with side portion 602 of beverage containing massage device 100, such as, by way of example and not limitation, one or more grooves, ridges, bumps, protrusions, and the like, as well as any combination thereof.

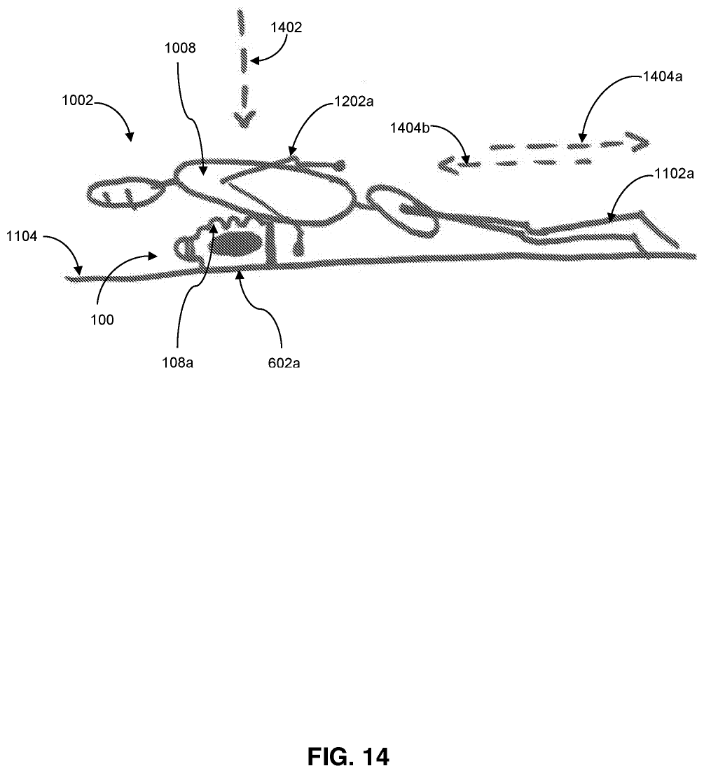

Referring now to FIG. 14, an image of a user 1002 using an exemplary beverage containing massage device 100 to massage one or more front portions of a torso 1008 of user 1002 using one or more massage balls 108, according to an aspect of the present disclosure, is shown.

In some nonlimiting exemplary embodiments, beverage containing massage device 100 may be placed on a substantially horizontal, flat, and rigid surface 1104 (such as, by way of example and not limitation, a section of interior flooring, the ground outdoors, a mat, etc.) such that at least one substantially flat side portion 602 (labeled only as side portion 602a in FIG. 14, for clarity) of beverage containing massage device 100 may be in substantially even contact with horizontal surface 1104. In some aspects, horizontal surface 1104 may comprise an at least slightly raised surface, such as, by way of example and not limitation, a table, desk, couch, bed, and the like. In some additional aspects, horizontal surface may be at least slightly inclined, such as, for example and not limitation, being inclined approximately thirty degrees. In some aspects, the side portion 602 that contacts horizontal surface 1102 may be substantially opposite to the side of beverage containing massage device 100 that comprises one or more massage balls 108 (labeled only as massage ball 108a in FIG. 14, for clarity). With this orientation, user 1002 may lay, kneel, crouch, or otherwise position the body of user 1002 such that a front portion of torso 1008 of user 1002 (e.g., chest, shoulder(s), abdomen, etc.) may be placed in contact with one or more massage balls 108 such that the direction of the applied gravitational force (represented by arrow 1402) may be in a generally downward direction the pushes one or more front portions of torso 1008 of user 1002 onto massage ball(s) 108. The applied force may have the effect of massaging or otherwise manipulating one or more soft tissues at or near the region of contact between the body of user 1002 and massage ball(s) in order to break up adhesions and/or improve cardiovascular circulation therein and/or relieve tension and/or soreness associated therewith. By way of example and not limitation, user 1002 may achieve the desired force application by allowing gravity to push the desired front portion(s) of torso 1008 of user 1002 onto the exposed portion(s) of massage ball(s) 108 at various angles in order to adjust the direction of force applied to the body and achieve different massaging effects. Additionally, various movements may also be used by user 1002 as needed in order to experience different massaging effects. In some exemplary instances, user 1002 may even move one or more lower limbs 1102 (labeled only as lower limb 1102a in FIG. 14, for clarity) and/or one or more upper limbs 1202 (labeled only as upper limb 1202a in FIG. 14, for clarity) in order to achieve a further variety of massaging effects by getting torso 1008 to move horizontally back and forth across massage ball(s) 108, as represented by directional arrows 1404a-b.

As will be appreciated by those skilled in the relevant art(s) after reading the description herein, some or all of the applications of massage roller 106 may be performed using massage ball(s) 108, and vice versa, without departing from the scope of the present disclosure. Additionally, as will also be appreciated by those skilled in the relevant art(s) after reading the description herein, entirely different massaging apparatuses may be used to perform the function(s) of massage roller 106 and/or massage ball(s) 108

While various aspects of the present disclosure have been described above, it should be understood that they have been presented by way of example and not limitation. It will be apparent to persons skilled in the relevant art(s) that various changes in form and detail can be made therein without departing from the spirit and scope of the present disclosure. Thus, the present disclosure should not be limited by any of the above described exemplary aspects.

In addition, it should be understood that the figures in the attachments, which highlight the structure, methodology, functionality and advantages of the present disclosure, are presented for example purposes only. The present disclosure is sufficiently flexible and configurable, such that it may be implemented in ways other than that shown in the accompanying figures (e.g., implementation with massaging apparatuses, materials, and uses other than those mentioned herein). As will be appreciated by those skilled in the relevant art(s) after reading the description herein, certain features from different aspects of the devices, apparatuses, and methods of the present disclosure may be combined to form yet new aspects of the present disclosure.

Further, the purpose of the foregoing Abstract is to enable the U.S. Patent and Trademark Office and the public generally and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of the present disclosure in any way.

What is claimed is:

1. A beverage containing massage device configured to contain at least one amount of at least one liquid and to manipulate at least one soft tissue of at least one user, the beverage containing massage device comprising:
at least one liquid reservoir configured to hold the at least one amount of the at least one liquid; and
at least one massaging apparatus configured to enable the at least one user to engage in the at least partially self-imposed manipulation of the at least one soft tissue.

2. The beverage containing massage device of claim 1, wherein the at least one liquid reservoir comprises at least one opening.

3. The beverage containing massage device of claim 2, wherein the beverage containing massage device further comprises at least one sealing element configured to at least partially block the at least one opening of the at least one liquid reservoir.

4. The beverage containing massage apparatus of claim 3, wherein the at least one sealing element comprises an upper portion that comprises a substantially hemispherical shape that is configured to manipulate the at least one soft tissue of the at least one user when pressed against at least one portion of a body of the at least one user that comprises the at least one soft tissue.

5. The beverage containing massage device of claim 4, wherein the at least one sealing element comprises at least one elongated member that spans from an upper portion of the at least one sealing element, through at least one portion of the at least one sealing element, and into a hollow portion of the at least one liquid reservoir.

6. The beverage containing massage device of claim 1, wherein the beverage containing massage device further comprises at least one substantially flat and substantially rigid side portion and a substantially flat and substantially rigid bottom portion.

7. The beverage containing massage device of claim 6, wherein the at least one substantially flat and substantially rigid side portion and the substantially flat and substantially rigid bottom portion comprise at least one at least partially malleable element, wherein the at least one at least partially malleable element is removable.

8. The beverage containing massage device of claim 7, wherein the at least one at least partially malleable element comprises at least one of: foam, rubber, one or more plastics, vinyl, cotton, one or more fabrics, leather, and one or more polymers.

9. The beverage containing massage device of claim 1, wherein the at least one massaging apparatus comprises at least one of: at least one massage roller and at least one massage ball.

10. The beverage containing massage device of claim 9, wherein the at least one massage roller is at least partially contained within at least one roller capture housing.

11. The beverage containing massage device of claim 10, wherein the at least one roller capture housing is at least partially contained within at least one indentation within at least one portion of the beverage containing massage device.

12. The beverage containing massage device of claim 10, wherein the at least one massage roller comprises at least one shaft member about which at least one roller portion revolves.

13. The beverage containing massage device of claim 12, wherein at least one portion of the at least one shaft member is at least partially contained within the at least one roller capture housing by at least one receiving element.

14. The beverage containing massage device of claim 9, wherein the at least one massage ball is at least partially contained within at least one recess within at least one portion of the beverage containing massage device.

15. The beverage containing massage device of claim 9, wherein the at least one massage ball is at least partially contained within at least one at least partially rigid planar massage ball holder.

16. The beverage containing massage device of claim 15, wherein the at least one massage ball and the at least one massage ball holder are at least partially contained within at least one recess within at least one portion of the beverage containing massage device.

17. The beverage containing massage device of claim 14, wherein the at least one massage ball is configured to freely rotate in any direction within the at least one recess.

18. The beverage containing massage device of claim 9, wherein the at least one massage roller comprises at least one roller portion that comprises at least one of: foam, vinyl, one or more plastics, rubber, leather, and one or more polymers.

19. The beverage containing massage device of claim 9, wherein the at least one massage ball comprises at least one of: stainless steel, one or more plastics, rubber, one or more metals, and one or more polymers.

20. The beverage containing massage device of claim 1, wherein the at least one liquid reservoir comprises at least one of: a canister, a bottle, a cup, a carafe, a mug, a flask, and a jug.
